(19) United States
(12) Patent Application Publication
(10) Pub. No.: US 2004/0124085 A1
(43) Pub. Date: Jul. 1, 2004

(54) Microfluidic devices and methods with electrochemically actuated sample processing

(75) Inventors: Yu-Chong Tai, Pasadena, CA (US); Jun Xie, Pasadena, CA (US); Qing He, Pasadena, CA (US); Terry Dwight Lee, San Dimas, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: California Institute of Technology, Pasadena, CA (US); City of Hope, Duarte, CA

(21) Appl. No.: 10/603,573

(22) Filed: Jun. 24, 2003

Related U.S. Application Data
(60) Provisional application No. 60/391,822, filed on Jun. 26, 2002.

(51) Int. Cl. G01N 27/27

(52) U.S. Cl. 204/600; 204/450

(57) ABSTRACT

Electrochemical actuation is adopted in an integrated microfluidic chip to transfer fluid for sample preparation, separation and detection. The electrochemical actuation is capable of producing high pressure for on-chip fluidic handling. Technologies and methods are also developed to use only electrical source to control on-chip fluid handling without any external fluidic support. Applications for the devices and methods include micro scale HPLC, ESI-MS, etc.

### CROSS-REFERENCES TO RELATED APPLICATIONS

This application claims priority to U.S. Provisional No. 60/391,822 filed Jun. 26, 2002, which is incorporated by reference herein.

### STATEMENT AS TO RIGHTS TO INVENTIONS MADE UNDER FEDERALLY SPONSORED RESEARCH OR DEVELOPMENT

Work described herein has been supported, in part, by NSF Grant No. EEC-9402726 and NIH Grant No. R01 RR06217. The United States Government may therefore have certain rights in the invention.

### BACKGROUND OF THE INVENTION

The present invention relates generally to microfluidic techniques. More particularly, the invention provides a method and system for performing a fluid transfer process using electrical energy through one of a plurality of microfluidic channels. Merely be way of example, the invention has been applied to a high pressure liquid chromatography process using an integrated microfluidic chip. But it would be recognized that the invention has a much broader range of applicability such as drug delivery, portable chemical analysis system, and the like.

Over the years, chemical analysis techniques have progressed. In the early days, analysis procedures included liquid chromatography, which relates to a process for isolation had purification of compounds. In the early days, commercial liquid chromatographic methods were plagued with difficulties for a laboratory scientist. Later on, certain chemical separations used techniques such as open-column chromatography, paper chromatography, and thin-layer chromatography. Unfortunately, certain limitations existed with these techniques. For example, these chromatographic techniques were often inadequate for quantification of compounds and resolution between similar compounds. Accordingly, pressure liquid chromatography was developed. Such pressure chromatography improved flow through time, which often reduced purification times of certain compounds being isolated by the column approach. Unfortunately, flow rates were often inconsistent, See, Analytical Chem. Volume 62, Number 19, Oct. 1, 1990.

Accordingly, high pressure liquid chromatography (“HPLC”) was developed to resolve some of these limitations of prior techniques. High pressure liquid chromatography improved development of column design and materials. Improvements to high pressure liquid chromatography improved separation between certain compounds, which were similar. More recently, computers and other automation have been added to HPLC for efficiency. Other techniques rely upon electro-osmotic forces for HPLC. An example of such HPLC has been described in U.S. Pat. No. 6,572,749, titled Electrokinetic High Pressure Hydraulic System (herein “the '749 patent”). The '749 patent generally claims an apparatus for fluid flow using electro-osmotic force applied to an electrolyte. The electro-osmotic force is used for an HPLC application. Unfortunately, numerous limitations exist with the electro-osmotic technique for HPLC. For example, electro-osmotic flow using electric fields to cause pressure for pumping and/or compressing liquids. In order to achieve a high pressure, a high voltage, such as 3000 volts, is usually needed. Additionally, the packing of porous materials inside the microchannel is also desired. Although HPLC has improved over the years, many limitations still exist.

From the above, it is desired to have an improved HPLC technique.

### BRIEF SUMMARY OF THE INVENTION

According to the present invention, techniques for microfluidic applications are provided. More particularly, the invention provides a method and system for performing a fluid transfer process using electrical energy through one of a plurality of microfluidic channels. Merely be way of example, the invention has been applied to a high pressure liquid chromatography process using an integrated microfluidic chip. But it would be recognized that the invention has a much broader range of applicability such as drug delivery, portable chemical analysis system, and the like.

In a specific embodiment, the invention provides a microfluidic system for liquid chromatography. The system includes a substrate, which has various elements. An electrochemical pump system is disposed on the substrate, the pump system having a plurality of electrolysis pumps and at least one outlet. Each of the pumps has at least one outlet. Each electrolysis pump has a chamber and a plurality of electrodes, which are coupled to an electrical source. A fluid is inside the chamber and is contacted with the electrodes. The pump also has an inlet and an outlet. A separation column is disposed on the substrate. The column has an inlet and an outlet. An micro channel is defined between the inlet and outlet. A solid stationary phase material (e.g., silica and alumina) is packed inside the micro channel. Preferably, the inlet of the separation column is coupled to the at least one outlet of the electrochemical pump system. The electrochemical pump system and the separation column are configured such that the electrochemical pump system provides an elution for a separation process within the separation column.

In an alternative specific embodiment, the invention provides a microfluidic system for electrospray ionization (ESI) and mass spectrometry (MS). The system has a substrate and an electrochemical pump system is disposed on the substrate. The electrochemical pump system has a plurality of electrolysis pumps and at least one outlet. Each pump includes a chamber and a plurality of electrodes, which are coupled to an electrical source. A fluid is inside the chamber and is preferably contacted with the electrodes. The pump also has an inlet and an outlet.

Preferably, an electrospray ionization (ESI) nozzle is also disposed on the substrate. The ESI nozzle has an inlet, an outlet, a micro channel coupled between the inlet and the outlet, and an ESI electrode within the micro channel. The inlet of the ESI nozzle can be coupled to the outlet of the electrochemical pump system. The system also has a mass spectrometer including an inlet, which is coupled to the outlet of the ESI nozzle. The electrochemical pump system and the ESI nozzle are configured such that the electrochemical pump system provides a driving force to cause the fluid to flow through the micro channel of the ESI nozzle and flow out through the outlet of the ESI nozzle, and the fluid emitted from the outlet of the ESI nozzle is transferred to the mass spectrometer as a voltage source is applied between the ESI electrode and the mass spectrometer.

In yet an alternative embodiment, the invention provides a method for transferring fluid on a microfluidic chip based on an electrochemical actuation. The method includes transferring a fluid into a chamber through an inlet within the substrate and providing an electrical connection using a plurality of electrodes coupled to the chamber. The method includes transferring a portion of the fluid from the chamber through an outlet while applying an electrical energy to the plurality of electrodes using the electrical connection, whereupon the portion of the fluid is transferred free from any coupling to an external fluidic source. The transferring a portion of the fluid is performed in response to the electrical energy applied to the plurality of electrodes.

Still further, the invention provides a method for controlling fluid through a microfluidic system in a liquid chromatography application. The method applies an electrical source between the plurality of electrodes to cause an electrochemical reaction within a first fluid in a chamber coupled to the plurality of electrodes. The method generates a gaseous species from the electrochemical reaction in the first fluid to increase a pressure within the chamber. Preferably, the method transfers a second fluid through a separation column to separate one or more components in the second fluid using the pressure associated with the chamber for liquid chromatography.

Still further in yet an alternative embodiment, the invention provides a method for performing liquid chromatography using a multi-chamber arrangement. The method includes applying an electrical source between a plurality of electrodes to cause an electrochemical reaction within a first fluid in a first chamber. Preferably, the first chamber is among a plurality of chambers. Each of the chambers is numbered from 1 through N, where N is an integer greater than 1. The first fluid is among a plurality of fluids numbered from 1 through N, where each of the fluids is respectively associated with at least one of the chambers. The method includes generating a gaseous species from the electrochemical reaction in the first fluid to increase a first pressure within the first chamber, and transferring a first liquid chromatography fluid from a first reservoir to a separation column using the first pressure associated with the first chamber. The first liquid chromatography fluid is from a plurality of liquid chromatography fluids numbered from 1 through N. Each of the liquid chromatography fluids is associated with a respective reservoir chamber also numbered from 1 through N. Depending upon the embodiment, the method further includes applying, generating, and transferring for any of the other chambers including any of the other respective fluids and reservoirs.

In an alternative specific embodiment, the invention provides a method for controlling fluid through a microfluidic system for ESI-MS. The method includes transferring a first fluid from an inlet into a chamber, which is formed on a first portion of a substrate. The chamber has a plurality of electrodes, which are configured to apply electrical forces to the first fluid. The method includes applying an electrical source between the plurality of electrodes and causing an electrochemical reaction within the chamber based upon the application of the electrical source onto the electrodes, the electrodes being coupled to the first fluid. The method also includes generating a gaseous species from the electrochemical reaction to increase a pressure within the chamber. The pressure in the chamber is used to provide a driving force for injection of a second fluid for ESI-MS. Preferably, the injection is controlled by adjusting an electrical source coupled to the plurality of electrodes.

Numerous benefits are achieved using the present invention over conventional techniques. For example, the invention can be applied for Mass Spectrometry (MS) and other applications. Preferably, the invention provides a system that is integrated with various microfluidic components, such as electrolysis-based micro pump, micro mixer, and electro spray ionization (ESI) nozzle, among other elements. Depending upon the embodiment, multi-layered Parylene surface micromachining have been used, although other fabrication techniques can also be used. Additionally, application of the present system includes multisource precise dispensing for MS and gradient elution for HPLC. By using the present method, complex fluidic handling can be done on a single chip and the use of only electrical control also simplifies automation in certain embodiments. The system can also be mass produced at lower costs for commercialization. Depending upon the embodiment, one or more of these benefits may exist. These and other benefits have been described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified diagram of an integrated system according to an embodiment of the present invention.

FIG. 2 is a more detailed diagram of an integrated HPLC system according to an embodiment of the present invention.

FIGS. 3A, 3B, and 3C are simplified diagrams of electrolysis pumps according to embodiments of the present invention.

FIG. 4 is a simplified diagram of an integrated HPLC system with a sample injection according to an embodiment of the present invention.

FIG. 5 is a simplified diagram of an integrated HPLC system with a sample injection according to an alternative embodiment of the present invention.

FIG. 6 is an integrated HPLC-ESI-MS system according to an embodiment of the present invention.

FIG. 7 is an integrated ESI-MS system according to an alternative embodiment of the present invention.

FIG. 8 is a HPLC system with a multi-chamber arrangement for electrolysis pump according to an embodiment of the present invention.

FIGS. 9 through 18 are simplified diagrams of experimental results according to embodiments of the present invention.

### DETAILED DESCRIPTION OF THE INVENTION

According to the present invention, techniques for microfluidic applications are provided. More particularly, the invention provides a method and system for performing a fluid transfer process using electrical energy through one of a plurality of microfluidic channels. Merely be way of example, the invention has been applied to a high pressure liquid chromatography process using an integrated microfluidic chip. But it would be recognized that the invention has a much broader range of applicability such as drug delivery, portable chemical analysis system, and the like.

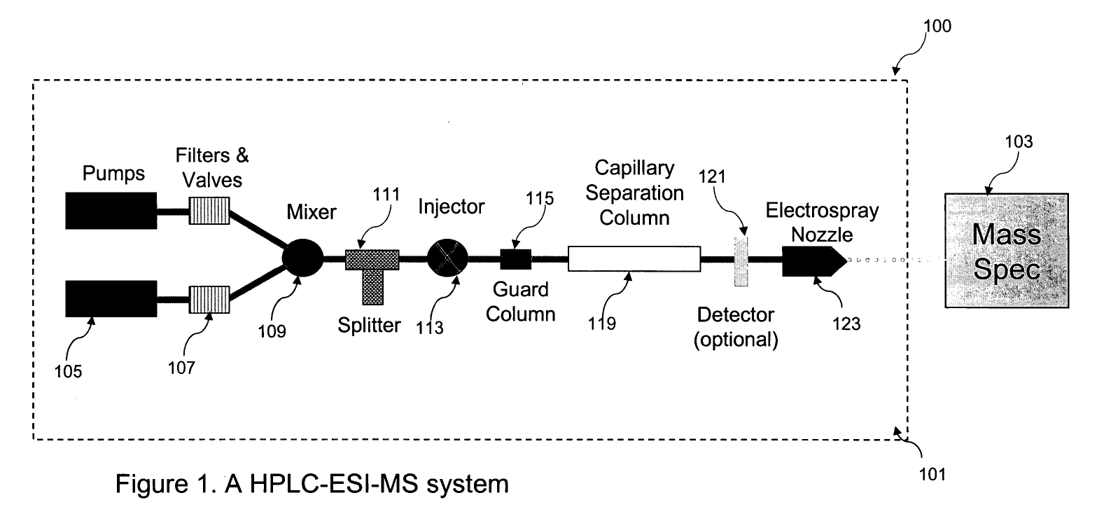

FIG. 1 is a simplified diagram of an integrated system 100 according to an embodiment of the present invention. This diagram is merely an example, which should not unduly limit the scope of the claims herein. One of ordinary skill in the art would recognize many variations, alternatives, and modifications. As shown, the integrated microfluidic system 100 is for liquid chromatography and preferably for mass spectroscopy. The system includes a substrate 101. The substrate can be made of a variety of materials. Such materials include single materials, alloys, and multilayered structures, or any combination of these. The substrate can be made of silicon, glass, plastic, and various polymer materials. Of course, the substrate used will depend upon the application.

As shown, the system includes an electrochemical pump system 105 (e.g., plurality or single) on the substrate. Each of the pumps has at least one outlet. Each of the pumps includes elements such as a chamber, a plurality of electrodes, which are coupled to an electrical source, a fluid inside the chamber, and an inlet and an outlet. Fluid enters the inlet and exits the outlet. The system also includes a separation column 119 on the substrate having an inlet and an outlet. The separation column also has a micro-channel, a solid stationary phase material packed inside the micro-channel. The inlet of the separation column is coupled to the outlet of the electrochemical pump. The electrochemical pump system and the separation column are configured such that the electrochemical pump system provides the elution for the separation process inside the separation column.

Depending upon the embodiment, other elements can also be integrated onto the substrate. These elements include filters and valves 107, a mixer 109, a splitter 111, an injector 113, a guard column 115, a detector 121, and an electro-stray tip or nozzle 123. Each of these elements are fabricated on the substrate using the techniques described herein, but can also be other techniques. The mass spectrometer 103 is coupled to the nozzle but is often outside of the integrated elements on the substrate. Other systems can also be coupled to the separation column. These systems include, among others, a UV analyzer, a conductivity analyzer, a refractive index analyzer, a fluorescence analyzer, an electrochemical analyzer, a light scattering analyzer. These and other features of the system are described in more detail throughout the present specification and more particularly below.

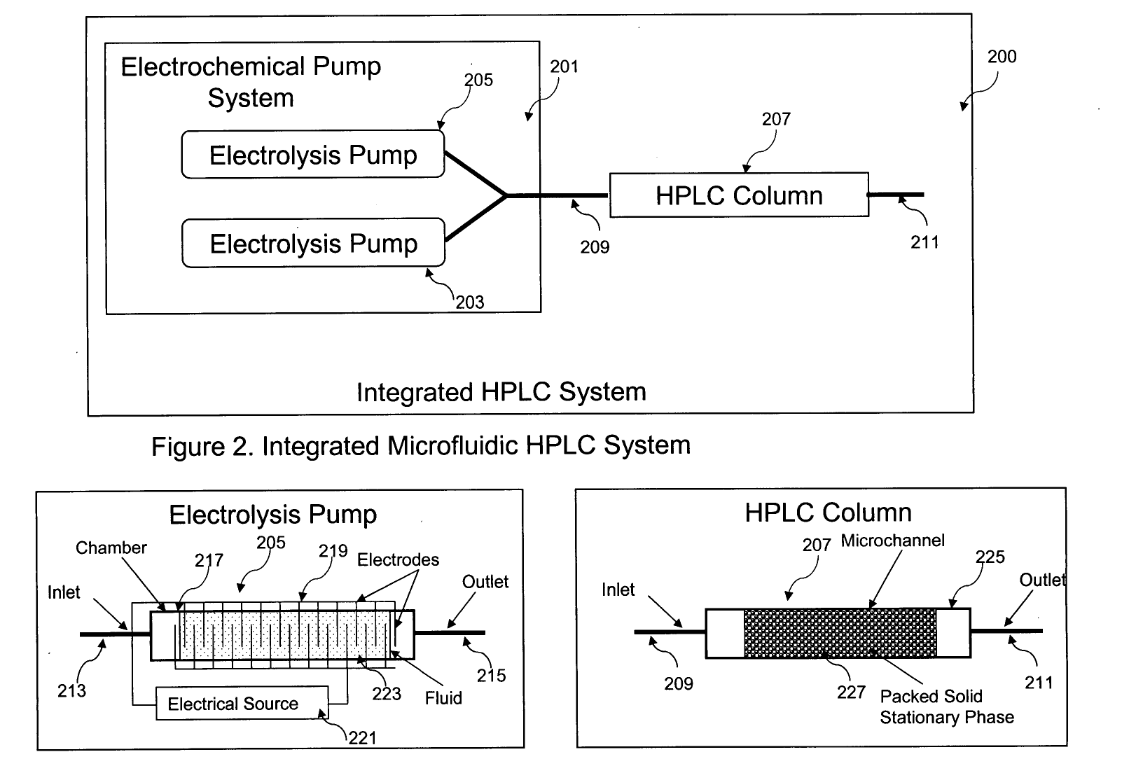

FIG. 2 is a more detailed diagram of an integrated HPLC system 200 according to an embodiment of the present invention. This diagram is merely an example, which should not unduly limit the scope of the claims herein. One of ordinary skill in the art would recognize many variations, alternatives, and modifications. As shown, the system includes an electrochemical pump system 201 (e.g., plurality or single), which includes a plurality of electrolysis pumps 203, 205 on the substrate. Each of the electrolysis pumps has at least one outlet 215. Each of the electrolysis pumps include elements such as a chamber 217, a plurality of electrodes 219, which are coupled to an electrical source 221, a fluid 223 (e.g., an electrolyte that is selected from organic liquid, inorganic liquid, or the combination of inorganic or organic liquid (e.g., acetonitrile, methanol, ethanol)) inside the chamber, and an inlet 213 and the outlet 215. The chamber can be made of suitable materials, e.g., Parylene, SU-8, silicone, silicon, silicon oxide, glass, Teflon, PEEK, other polymer materials or any combination of these materials. The electrodes are made of a suitable material that is conductive. Such electrode material may include, among others, carbon, platinum, gold, aluminum, titanium, chromium, and other noble metals. Fluid enters the inlet and exits the outlet.

The system also includes an separation column 207 on the substrate having an inlet 209 and an outlet 211. The column also has a micro-channel 225, a solid stationary phase material 227 packed inside the micro-channel. The inlet of the separation column is coupled to the outlet of the electrochemical pump, as shown. Depending upon the embodiment, other elements may be disposed between the pump and separation column. The electrochemical pump system and the separation column are configured such that the electrochemical pump system provides the elution for the separation process inside the separation column. Further details of a method according to the present invention are provided in more detail below.

According to a specific embodiment, the system can perform a variety of methods. An example of such a method is for controlling fluid through the present microfluidic system in a liquid chromatography application. The method includes transferring fluid from the inlet into the chamber. An electrical source is applied between the plurality of electrodes. The electrical source can be a voltage source or a current source or a voltage/current source. Here, the electrolysis pump is adapted to maintain a pressure on the fluid in the chamber while the electrodes are biased using the electrical source. Electrical energy from the source causes an electrochemical reaction within the chamber based upon the application of the electrical source onto the electrodes. Preferably, the electrodes are directly coupled to the fluid. To cause a pumping action, a gaseous species is generated from the electrochemical reaction to increase a pressure within the chamber. The pressure is used to provide driving force for an elution in the separation column for liquid chromatography. In a specific embodiment, the pressure can be higher than 1000 psia or less than 1000 psia or less than 100 psia. Depending upon the embodiment, the method can also control the liquid chromatography process. Here, control can be achieved by adjusting the electrical source that applies the plurality of electrodes.

In a specific embodiment, the system and method provides for selected fluid flow. Here, fluid output from the chamber can be about 1 micro liter of fluid. Alternatively, the fluid output from the chamber can be greater than about 1 micrometer of fluid. Alternatively, the fluid output from the chamber can be less than about 1 micrometer of fluid. Alternatively, the electrochemical pump system is characterized to provide a flow rate of about 1 nanoliter per minute to about 1 micro liter per minute through the separation column. Alternatively, the electrochemical pump system is characterized to provide a flow rate of less than about 1 nanoliter per minute through the separation column or is characterized to provide a flow rate of greater than about 1 micro liter per minute through the separation column. Of course, the particular flow rate will depend upon the application. Depending upon the embodiment, each of the electrolysis pumps can be configured with respect to each other in alternative arrangements, including parallel, serial, and any combination of these.

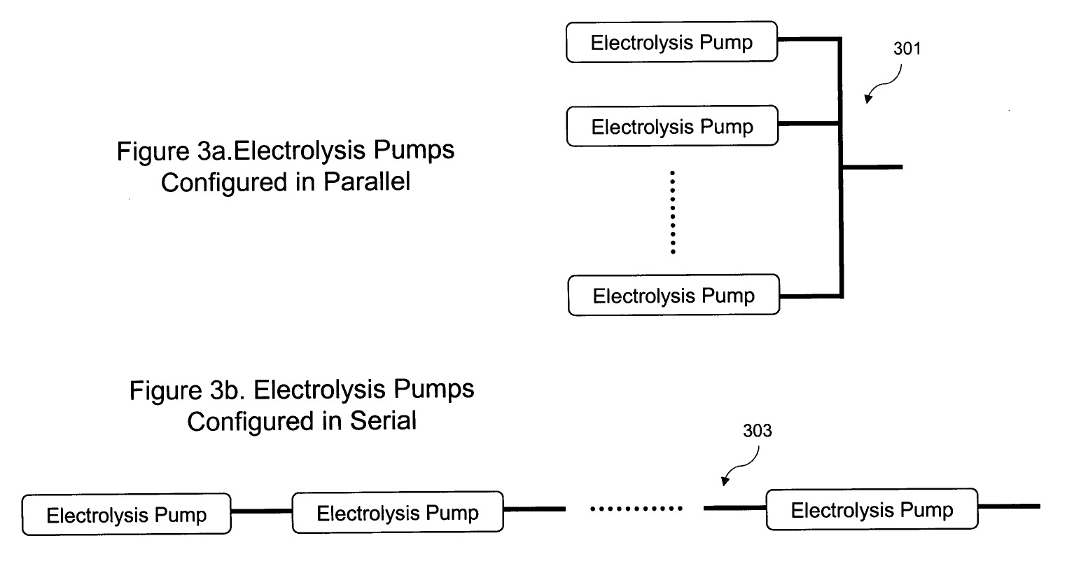

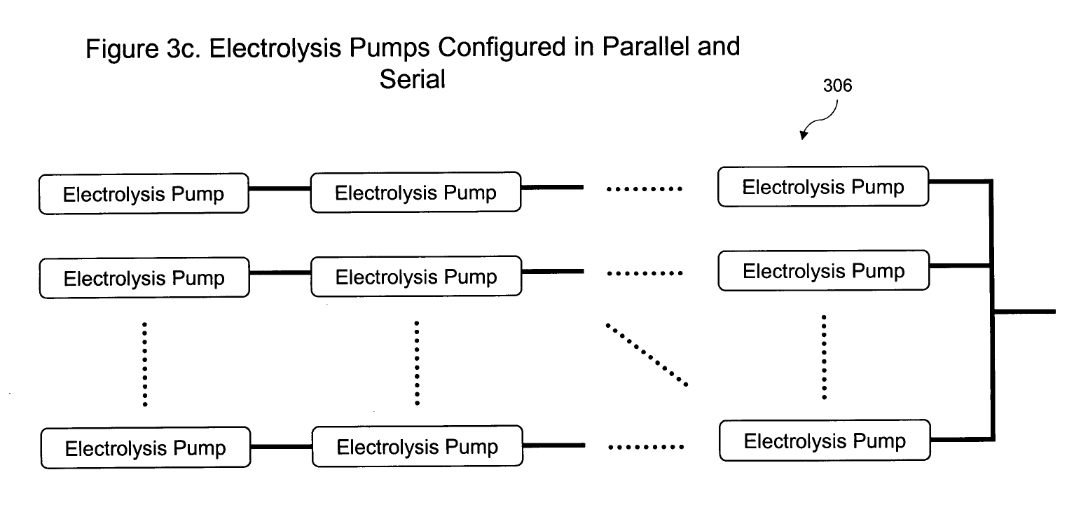

FIGS. 3A, 3B, and 3C are simplified diagrams of electrolysis pumps according to embodiments of the present invention. These diagrams are merely an example, which should not unduly limit the scope of the claims herein. One of ordinary skill in the art would recognize many variations, alternatives, and modifications. As shown, the pumps can be configured in parallel 301, or serial 303, or parallel and serial 306. The pumps in parallel each include an outlet that connects to a common port, which interfaces to another element. Each of the pumps can apply fluid together or any one of the pumps can apply fluid independent of the other or any sequential order. The pumps in serial configuration can also be applied together or sequentially or any one of the pumps can be applied independently of the others. Alternatively, the pumps in serial and parallel configuration could be applied in a number of different processes, which would be appreciated by one of ordinary skill in the art. The pumps in serial and parallel form an array of pumps, including N pumps in serial and M pumps in parallel, where N and M are greater than 1, in a specific embodiment.

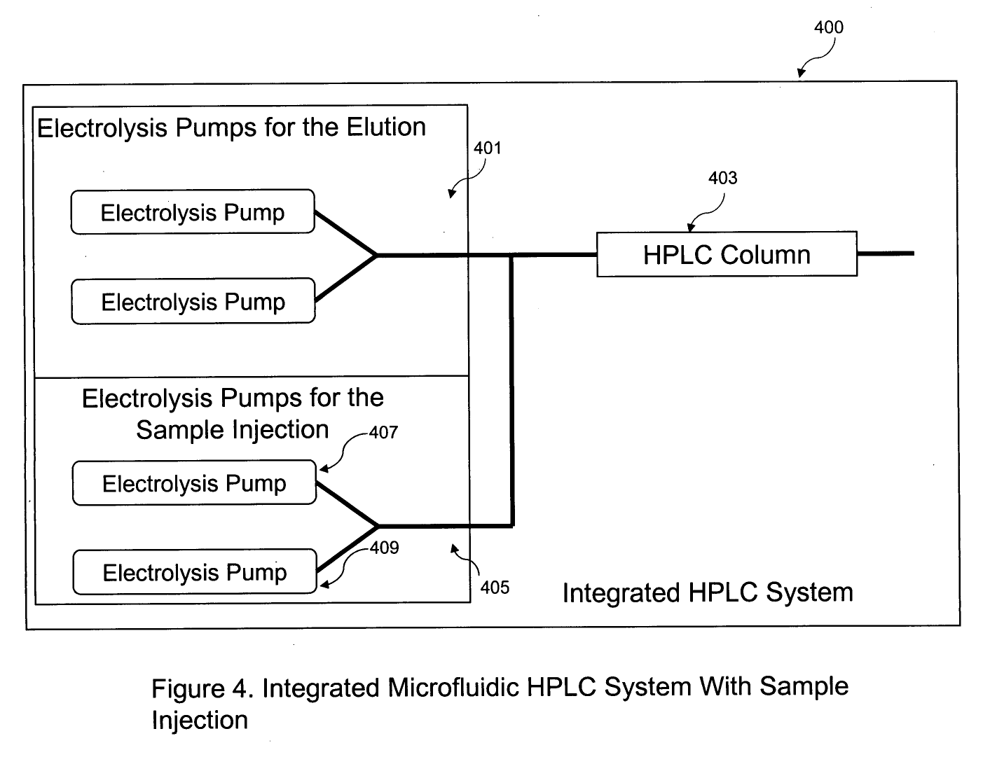

FIG. 4 is a simplified diagram of an integrated HPLC system 400 with a sample injection according to an embodiment of the present invention. This diagram is merely an example, which should not unduly limit the scope of the claims herein. One of ordinary skill in the art would recognize many variations, alternatives, and modifications. As shown, the system 400 includes a plurality of electrolysis pumps 401, which are configured in parallel. Each of these pumps is coupled to an inlet of an HPLC column 403. The HPLC column includes an outlet. Between the electrolysis pumps and column, sample injection source 405 is provided. The sample injection source includes a plurality of electrolysis pumps 407, which are configured in parallel, but may also be in serial, depending upon the embodiment. Each of the electrolysis pumps includes an outlet that is coupled to the inlet of the HPLC column. Depending upon the embodiment, various fluids can be provided within each of the electrolysis pumps in the sample injection source. Alternative embodiments of the sample injection source are provided throughout the present specification and more particularly below.

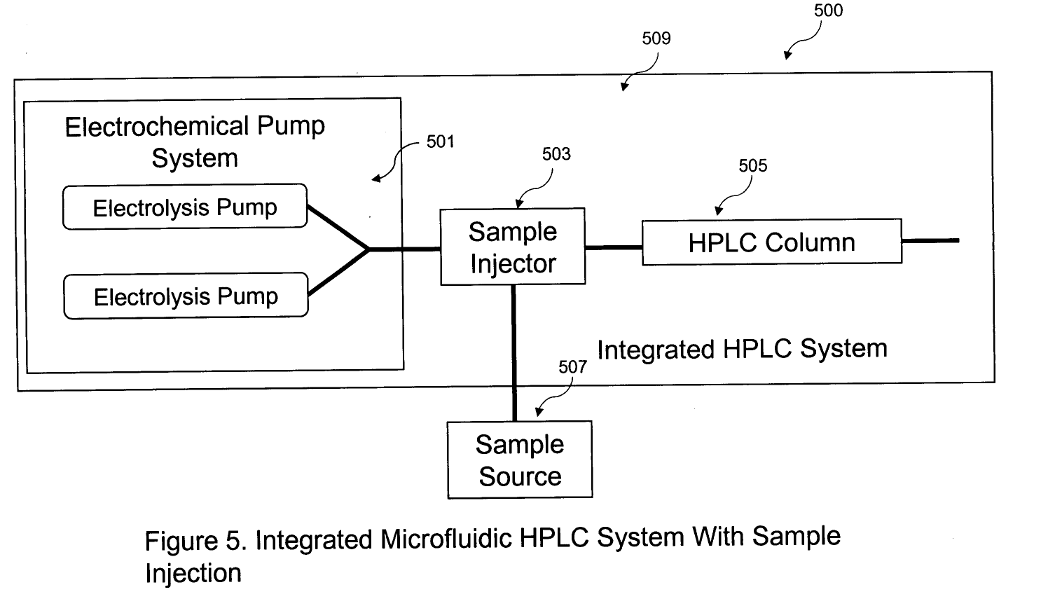

FIG. 5 is a simplified diagram of an integrated HPLC system 500 with a sample injection according to an alternative embodiment of the present invention. This diagram is merely an example, which should not unduly limit the scope of the claims herein. One of ordinary skill in the art would recognize many variations, alternatives, and modifications. As shown, the system 500 includes a plurality of electrolysis pumps 501, which are configured in parallel, on a substrate. Each of these electrolysis pumps is coupled to an inlet of an HPLC column 505. The HPLC column includes an outlet. Between the electrolysis pumps and column, sample injector 503 is provided. The sample injector is coupled to sample source 507, which may be outside of the substrate. Depending upon the embodiment, various fluids can be provided by the sample injector. Alternative embodiments of the system are provided throughout the present specification and more particularly below.

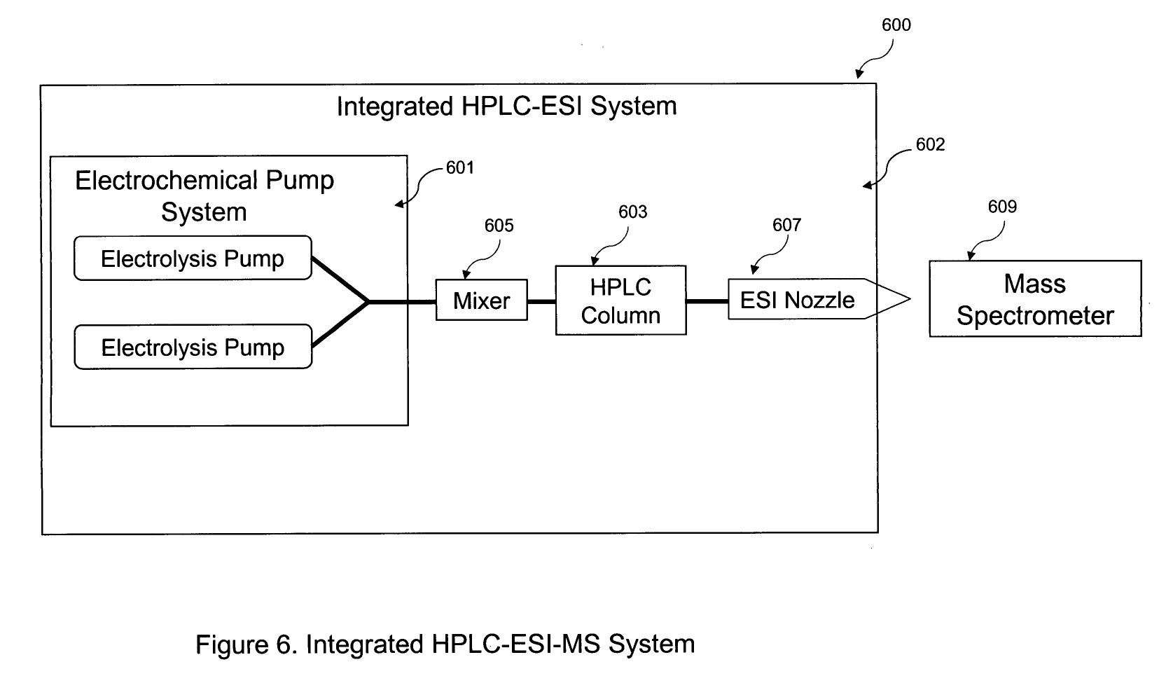

FIG. 6 is an integrated HPLC-ESI-MS system 600 according to an embodiment of the present invention. This diagram is merely an example, which should not unduly limit the scope of the claims herein. One of ordinary skill in the art would recognize many variations, alternatives, and modifications. As shown, the system 600 includes a plurality of electrolysis pumps 601, which are configured in parallel, on a substrate 602. Each of these electrolysis pumps is coupled to an inlet of an HPLC column 605. The HPLC column includes an outlet. Between the electrolysis pumps and column, mixer 605 is provided. Depending upon the embodiment, the mixer provides mixing of various fluids being pumped out of the electrolysis pumps. As noted HPLC column includes the outlet, which is connected to a nozzle 607. The nozzle is preferably an electrospray ionization (ESI) nozzle on the substrate having an inlet, an outlet, a micro-channel and an ESI electrode. The inlet of the ESI nozzle is coupled to the outlet of the HPLC column. The outlet of the ESI nozzle is coupled to a mass spectrometer 609, which is often outside of the substrate.

The electrochemical pump system and the ESI nozzle are configured such that the electrochemical pump system provides the driving force to push the fluid through the ESI nozzle. The fluid is emitted from the outlet of the ESI nozzle coupled to the mass spectrometer through ESI process while a high voltage source is applied between the ESI electrode and mass spectrometer according to a preferred embodiment. More preferably, the ESI electrode is contacted with the fluid pushed through the ESI nozzle. The nozzle can be made of a suitable material, e.g., Parylene, SU-8, silicone, silicon, silicon oxide, glass, Teflon, PEEK, and other polymer materials. The ESI electrode is made of a suitable material that is conductive. Such electrode material may include, among others, carbon, platinum, gold, aluminum, titanium, chromium, and other noble metals. Other embodiment of the system with the ESI nozzle is described below.

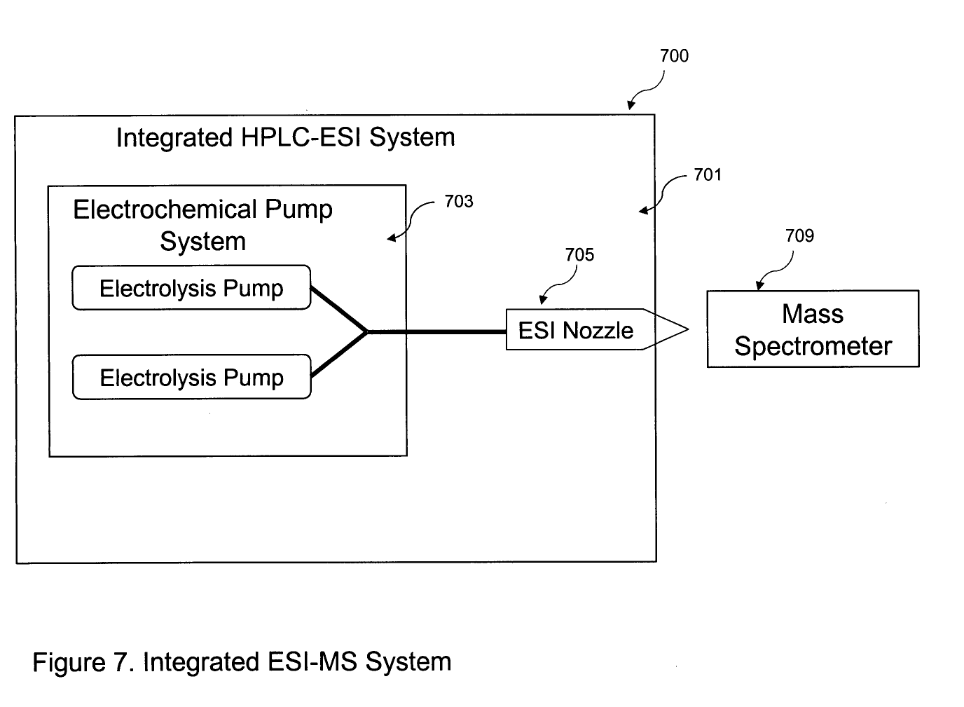

FIG. 7 is an integrated ESI-MS system 700 according to an alternative embodiment of the present invention. This diagram is merely an example, which should not unduly limit the scope of the claims herein. One of ordinary skill in the art would recognize many variations, alternatives, and modifications. As shown, the system 700 includes a plurality of electrolysis pumps 703, which are configured in parallel, on a substrate 701. Each of these electrolysis pumps is coupled to an ESI nozzle 705. The nozzle is preferably an electrospray ionization (ESI) nozzle on the substrate having an inlet, an outlet, a microchannel and an ESI electrode. The inlet of the ESI nozzle is coupled to the outlet of the electrolysis pumps. The outlet of the ESI nozzle is coupled to a mass spectrometer 709, which is often outside of the substrate.

The electrochemical pump system and the ESI nozzle are configured such that the electrochemical pump system provides the driving force to push the fluid through the ESI nozzle. The fluid is emitted from the outlet of the ESI nozzle coupled to the mass spectrometer through ESI process while a high voltage source is applied between the ESI electrode and mass spectrometer according to a preferred embodiment. More preferably, the ESI electrode is contacted with the fluid pushed through the ESI nozzle. The nozzle can be made of a suitable material, e.g., Parylene, SU-8, silicone, silicon, silicon oxide, glass, Teflon, PEEK, and other polymer materials. The ESI electrode is made of a suitable material that is conductive. Such electrode material may include, among others, carbon, platinum, gold, aluminum, titanium, chromium, and other noble metals. Other embodiment of the system with the ESI nozzle is described below.

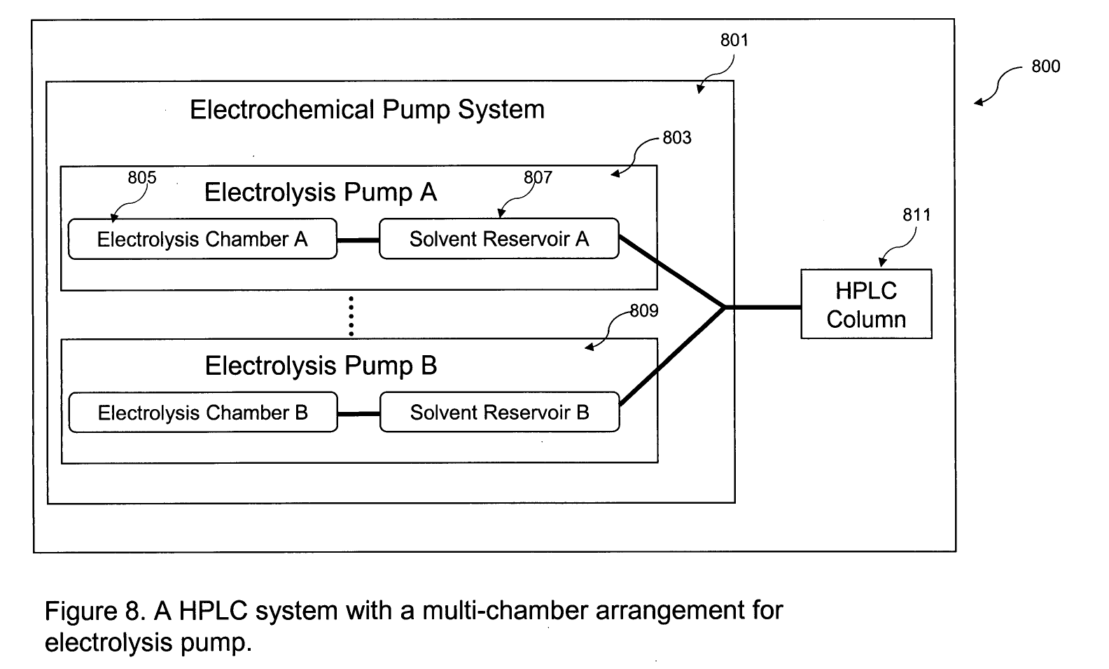

FIG. 8 is a HPLC system with a multi-chamber arrangement for electrolysis pump. This diagram is merely an example, which should not unduly limit the scope of the claims herein. One of ordinary skill in the art would recognize many variations, alternatives, and modifications. The system 800 includes an electrochemical pump system 801 and an HPLC column 811. The HPLC column 811 is coupled to the electrochemical pump system 801 such that the electrochemical pump system 801 provides the elution or sample injection for a separation process in the HPLC column 811. The electrochemical pump system 801 includes a plurality of electrolysis pumps, such as a pump A 803 and a pump B 809. In this embodiment, the plurality of electrolysis pumps is configured in parallel. The pump A 807 includes an electrolysis chamber 805 and a solvent reservoir 807. The pump A 803 is configured such that when an electrical energy is applied to the electrolysis chamber A 805, an electrochemical reaction would increase a pressure inside the electrolysis chamber A 805, and that pressure would provide the driving force to transfer a solvent inside the solvent reservoir A 807 to the HPLC column 811. A plurality of fluids can be used in the pump A 803. The fluid inside the electrolysis chamber A 805 can be a working media for the electrochemical reaction and the fluid inside the solvent reservoir A 807 can be a solvent or sample solution for the separation process. Other electrolysis pumps can be configured in a way substantially similar to the pump A 803.

With the HPLC system as shown in FIG. 8, a method for performing liquid chromatography with a multi-chamber arrangement can be performed. The method includes applying an electrical source between a plurality of electrodes to cause an electrochemical reaction within a fluid within the electrolysis chamber A 805. The electrolysis chamber A 805 is one of a plurality of chambers. The plurality of chambers include the electrolysis chamber A 805, the electrolysis chamber B, and other electrolysis chambers. Each electrolysis chamber belongs to an electrolysis pump. As shown in FIG. 8, the electrochemical pump system 801 includes electrolysis pump A, electrolysis pump B, and other electrolysis pumps.

The method also includes generating a gaseous species from the electrochemical reaction in the fluid to increase a pressure within the electrolysis chamber A 805, and transferring a liquid chromatography fluid from the solvent reservoir A 807 to the HPLC column 811 for liquid chromatography using the first pressure associated with the electrolysis chamber A 805. Additionally, the method applies the similar processes of applying, generating, and transferring to any of the other chambers and reservoirs. Each electrolysis chamber contains a fluid, and each solvent reservoir contains a liquid chromatography fluid. As further emphasized here, the method is merely an example, which should not unduly limit the scope of the claims herein. One of ordinary skill in the art would recognize many variations, alternatives, and modifications.

It is also understood that the examples and embodiments described herein are for illustrative purposes only and that various modifications or changes in light thereof will be suggested to persons skilled in the art and are to be included within the spirit and purview of this application and scope of the appended claims. Further details of specific applications of the present invention have been described throughout the present specification and more particularly below.

Experiments:

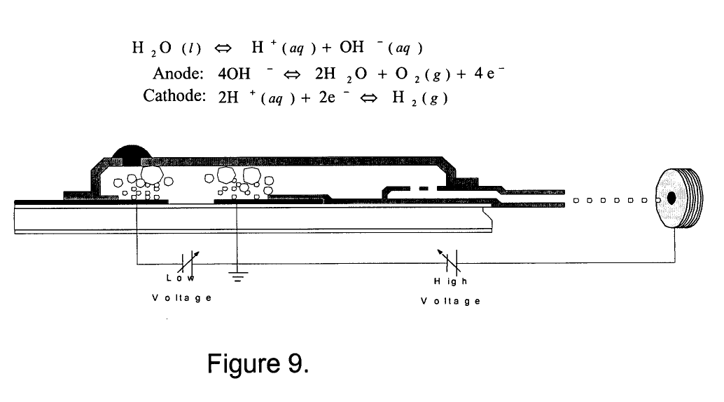

To prove the operation of the present invention, certain experiments have been performed. These experiments are merely examples and should not unduly limit the scope of the claims herein. One of ordinary skill in the art would recognize many alternatives, variations, and modifications. These experiments were provided in reference to FIGS. 9-18 are simplified diagrams of experimental results according to embodiments of the present invention. These diagrams are merely an example, which should not unduly limit the scope of the claims herein. One of ordinary skill in the art would recognize many variations, alternatives, and modifications.

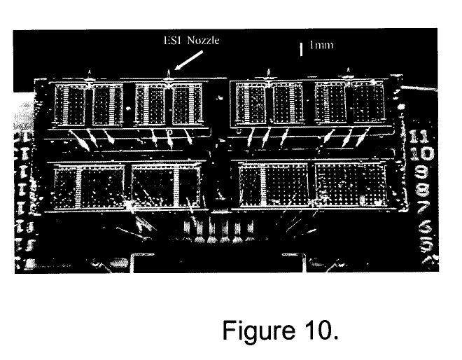

The technique of HPLC-ESI-MS, which is a combination of two powerful standalone analytical techniques, is an exciting development of recent times in analytical methodology. Although certain analytical applications of High-Performance Liquid Chromatography (HPLC) and MS have established, we have successfully made a polymer-based electro spray chips for mass spectrometry. Electrochemical micro actuation based on electrolysis has been demonstrated as a successful technique for microfluidic application. But usually the device involves relatively complicated packaging, such as wafer bonding. Here, we made an electrolysis-based micro pump using the Parylene surface micromachining technology we developed. With this technology, an electrolysis micro pump, a passive micro mixer, and an ESI nozzle have all been integrated on a single chip. No external fluidic coupling is needed. Samples are stored and sealed in reservoir, then are pumped out by bubble pressure generated by electrolysis. After mixing at micro mixer, samples are fed to MS inlet through an integrated ESI nozzle. This stand-alone system does not need complicated packaging and only electrical wire is connected to the chip. That simplifies the operation of this system. Operation principle and fabricated device are shown in FIGS. 9 and 10.

An important application for this integrated system is on-chip gradient elution. For most complex analyses in HPLC, gradient elution is required. In most cases, the gradient systems involve multiple solvent reservoirs, pumps and mixers. Certain components have already been integrated using the proposed method. The gradient flow rate, concentration ratio or gradient slope, and duration can all be controlled electrically by adjust the voltage or current applied to the electrolysis pumps whose chambers contain different fluids. There are other approaches to achieve the same functions. For example, the pumping can use, but not limit to, electrostatic pump, thermo pneumatic pump, electro hydrodynamic pump, electro osmotic or electrophoretic pump. Electrostatic actuation based pump has already under the study in our group. The mixer can be an active mixer using the similar actuation methods as the pump, such as electrostatic, acoustic or dielectrophoretic actuation. Other applicable materials can also be used. For example other polymers, such as PDMS, etc., or more traditional MEMS materials, such as polysilicon or metal. Fabrication methods are described in more detail below.

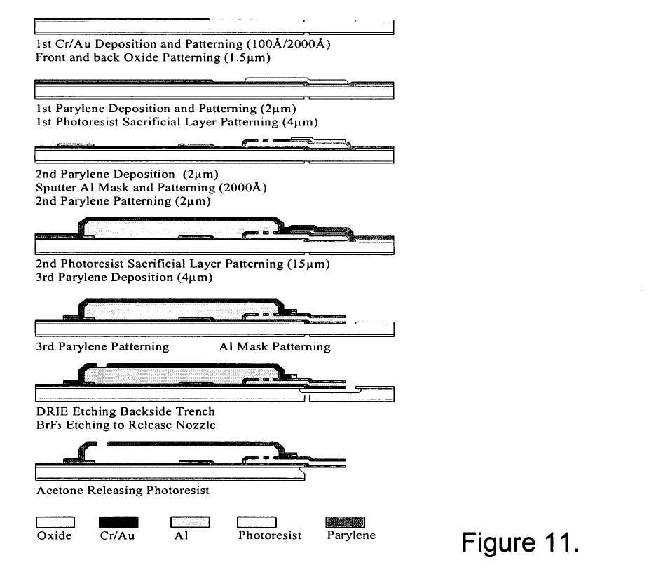

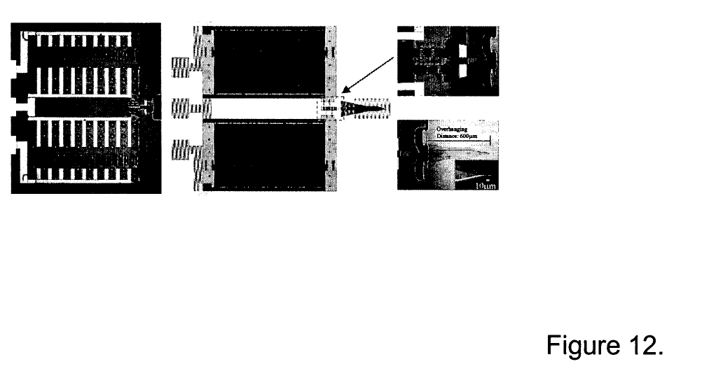

The device is fabricated by multi-layer Parylene surface micromachining technology. Process starts with oxide-coated silicon substrate. Electrodes for electrolysis are formed by Cr/Au (100 Å/2000 Å) layers. Then oxide on both sides is patterned to form BrF₃ and DRIE masks. The micro nozzle and mixer are constructed by one 4 μm photoresist sacrificial layer sandwiched by two 2 μm Parylene layers. A 2000 Å Al is patterned as Parylene mask to create sharp ESI nozzle. The reservoir is formed by a 15 μm photoresist sacrificial layer and 4 μm Parylene layer. Freestanding nozzle is created by etching away the silicon underneath using BrF₃. A trench by DRIE etching makes it easy to break the chip, so the nozzle overhangs out 600 μm. Finally, sacrificial layer is released by Acetone with ultrasonic stirring and followed by Methanol and DI water cleaning. FIG. 11 shows the detailed process flow. FIG. 12 gives simplified pictures about the micro pump, mixer and nozzle.

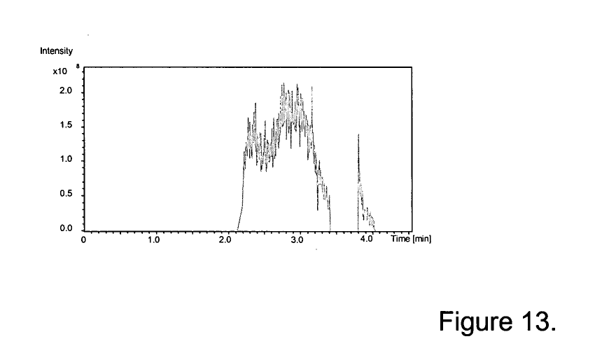

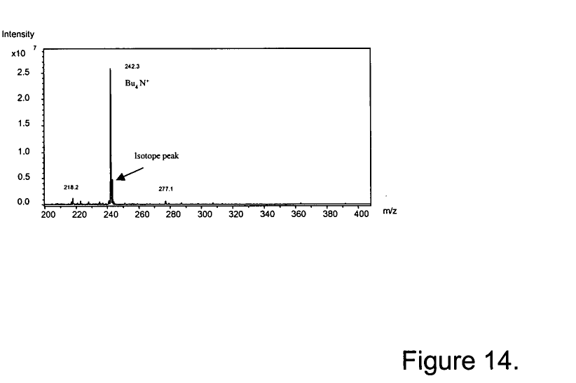

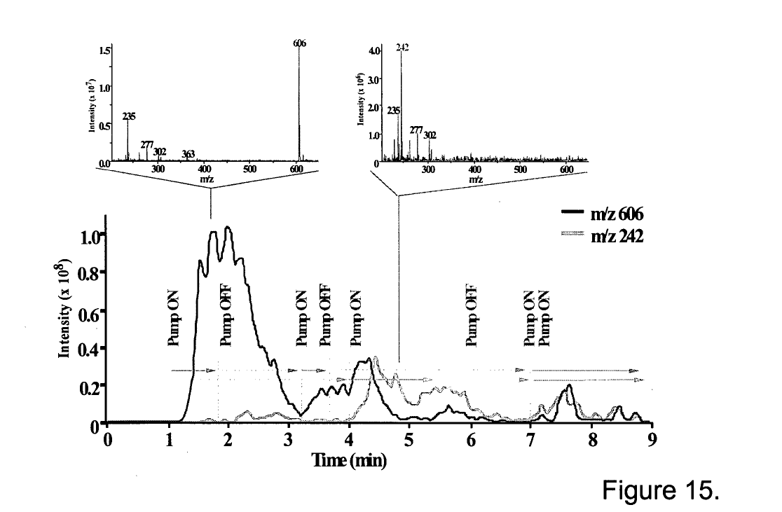

During testing, water-based solution containing 5% Methanol, 5% Acetic Acid and target sample (50 pmol/μL tetrabutyl ammonium iodide) was used. Sample solution was dropped onto inlet and photoresist was used to seal the inlet after the surface tension filled the reservoir (˜100 nL) with the solution. Then the chip was placed in front of MS inlet. An electrolysis voltage was applied along with a high voltage for ESI. FIGS. 13 and 14 present the result from the actual MS data using this integrated fluid dispensing system. Before the electrolysis voltage was applied there was no electro spray which means no signal. After electrolysis happened, the expected isotope peak of Bu₄N⁺ was observed in the mass spectrum. The flow rate is estimated to be around 80 nL/min. To further demonstrate the capability of this system, a multi-sample analysis has been done as shown in FIG. 15. Two different target samples were stored in the two reservoirs that are connected by mixer. Then by controlling the electrolysis voltage applied to each reservoir, we could control which sample solutions was fed into the nozzle and then finally got electro sprayed into MS. One chamber was filled with Tetrabutyl ammonium iodide (25 pmol/μl, m/z 242 marked as green line) and the other chamber with a peptide called leuprolide (30-50 pmol/μl, m/z 606 marked as red line). Both samples were dissolved in 5% methanol and 5% acetic acid. FIG. 15 shows the ion chromatograms for each sample and representative mass spectra at the times indicated. The experiments demonstrated the effectiveness of electrolysis micro pump, performance of the whole system and the essential idea of on-chip gradient elution.

An on-chip integrated microfluidic system for Mass Spectrometry (MS) is proposed and developed. The basic concept and design is discussed. One method of realization has been demonstrated which used multi-layer Parylene surface micromachining to achieve total integration of various microfluidic components, such as electrolysis-based micro pump, micro mixer and electro spray ionization (ESI). The application of proposed system includes multi-source precise dispensing and gradient elution for HPLC-ESI-MS system.

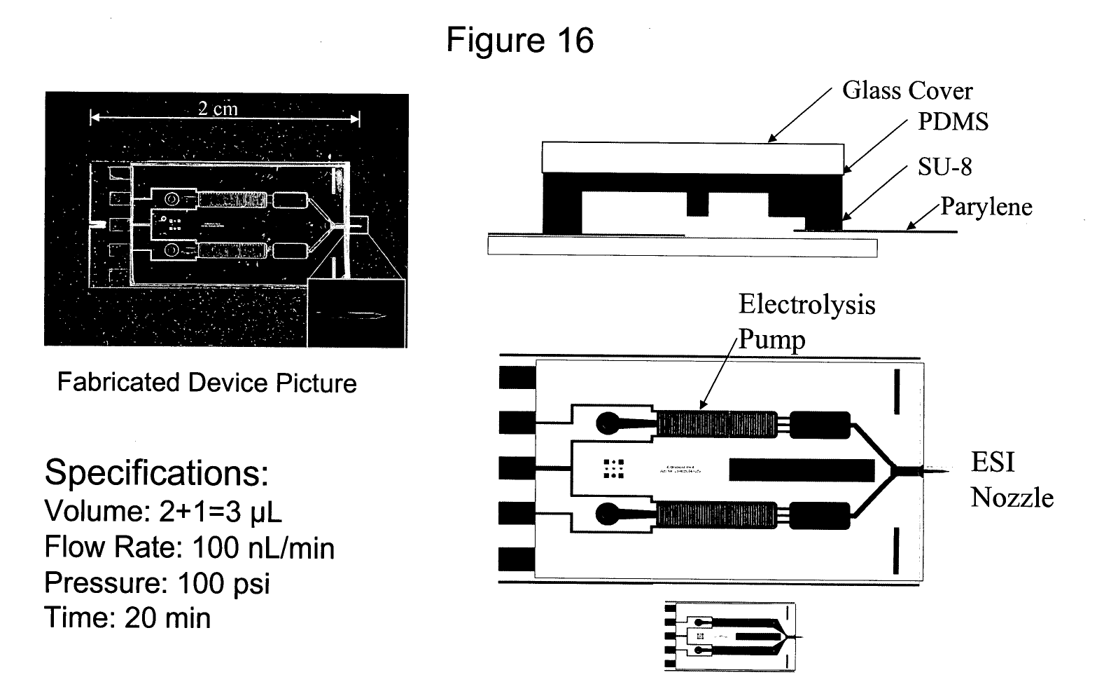

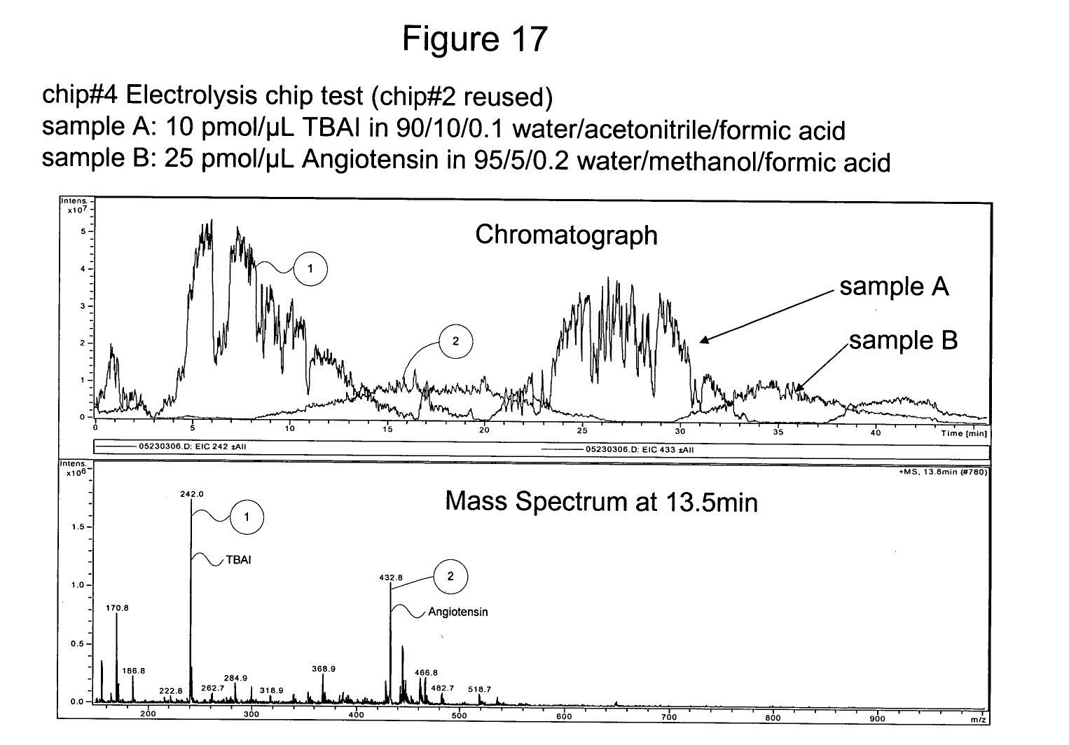

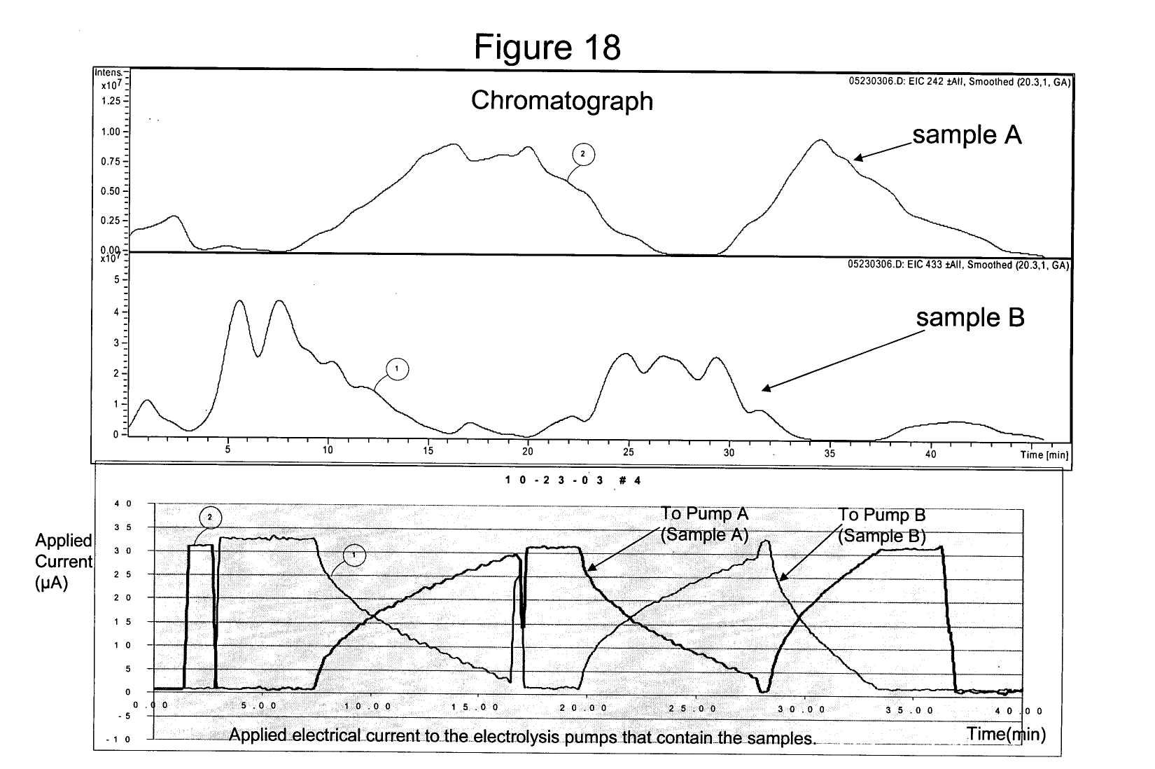

We have also demonstrated the present invention using a multiple pump configuration as illustrated by way of FIGS. 16 through 18. Referring to FIG. 16, a single chip design including two electrolysis chambers (as pumps) coupled to an ESI nozzle were disposed on the substrate. Each of the chambers included a plurality of electrodes that were coupled to external power sources. Each of the power sources were operated independently to demonstrate the present system and method. As merely an example, one of the chambers is provided with 10 pmol/μL TBAI in 90/10/0.1 water/acetonitrile/formic acid. The other chamber is provided with 25 pmol/μL Angiotensin in 95/5/0.2 water/methanol/formic acid. As can be see, each of the pumps is actuated with its selected fluid and the fluid has been outputted. The mass spectrophotometer reads the fluid outputted from the nozzle. TBAI was illustrated by a first peak and Angiotensin was illustrated by a second peak, which has been plotted against intensity in FIG. 17. Fluid flow can be individually controlled in response to the electrical current applied to the corresponding pumps and independent from each other, as also illustrated in FIG. 18 by the blue (reference numeral 1) and red (reference numeral 2) plots. Accordingly, we demonstrated accurate control over the output and distribution of the fluid from each of the chambers.

Referring to FIG. 18, we plotted current in micro amperes along a vertical axis, which intersects with a time axis. Current has been applied to one of the chambers to pump fluid there from, as represented by the red line (reference numeral 2), and then shut off, and on again. A counter current was provided on the other chamber, while the first chamber is turned off, as also illustrated. The mass spectrometer detects each of the fluids, which correspond also to the red line and blue line. Remarkably, control over output of the fluid is highly predictable and controllable by way of the present system and method. Of course, one of ordinary skill in the art would recognize other variations, modifications, and alternatives.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A microfluidic system for liquid chromatography, the system comprising:
a substrate;
an electrochemical pump system on the substrate, the electrochemical pump system comprising a plurality of electrolysis pumps and having at least one outlet; each of the electrolysis pumps comprising:
a chamber;
a plurality of electrodes, the electrodes being coupled to an electrical source;
a fluid inside the chamber, and the fluid being contacted with the electrodes; and
an inlet and an outlet;
an separation column on the substrate having an inlet and an outlet, an micro channel, a solid stationary phase material packed inside the micro channel, the inlet of the separation column being coupled to the at least one outlet of the electrochemical pump system; and
wherein the electrochemical pump system and the separation column are configured such that the electrochemical pump system provides an elution for a separation process inside the separation column.

2. The system of claim 1 wherein the plurality of electrolysis pumps are configured in parallel.

3. The system of claim 1 wherein the plurality of electrolysis pumps are configured in serial.

4. The system of claim 1 wherein the plurality of electrolysis pumps are configured in parallel and serial.

5. The system of claim 1 wherein the elution provided by the electrochemical pump system is isocratic elution.

6. The system of claim 1 wherein the elution provided by the electrochemical pump system is gradient elution.

7. The system of claim 1 wherein one of the electrolysis pumps is a sample injector and wherein the separation column is configured to perform a separation of one or more components of the sample dispensed from the sample injector as the rest of electrolysis pumps provide the elution for the separation column.

8. The system of claim 1 further comprising:
a sample source, the sample source comprising a sample;
an sample injector on the same substrate coupled between the electrochemical pump and the separation column, the sample injector being coupled to the sample source; and
wherein the separation column is configured to perform a separation of one or more components of the sample dispensed from the sample injector as the electrochemical pump system provides the elution for the separation column.

9. The system of claim 1 wherein the electrical source is selected from a group consisting of a voltage source, a current source, and a voltage/current source.

10. The system of claim 1 wherein the electrolysis pump is adapted to maintain a pressure on the fluid in the chamber while the electrodes are biased using the electrical source.

11. The system of claim 10 wherein the pressure is greater than 1000 psia.

12. The system of claim 10 wherein the pressure is less than 1000 psia.

13. The system of claim 10 wherein the pressure is less than 100 psia.

14. The system of claim 1 wherein the chamber comprises about 1 micro liter of fluid.

15. The system of claim 1 wherein the chamber comprises greater than about 1 micrometer of fluid.

16. The system of claim 1 wherein the chamber comprises less than about 1 micrometer of fluid.

17. The system of claim 1 wherein the electrochemical pump system is characterized to provide a flow rate of about 1 nanoliter per minute to about 1 micro liter per minute through the separation column.

18. The system of claim 1 wherein the electrochemical pump system is characterized to provide a flow rate of less than about 1 nanoliter per minute through the separation column.

19. The system of claim 1 wherein the electrochemical pump system is characterized to provide a flow rate of greater than about 1 micro liter per minute through the separation column.

20. The system of claim 1 wherein the chamber and the separation column are made of materials including Parylene.

21. The system of claim 1 wherein the chamber and the separation column are made of materials selected from a group consisting of SU-8, silicone, silicon, silicon oxide, glass, Teflon, PEEK, and other polymer materials.

22. The system of claim 1 wherein the electrodes are made of at least a material selected from a group consisting of carbon, platinum, gold, aluminum, titanium, chromium, and other noble metals.

23. The system of claim 1 wherein the fluid being an electrolyte that is selected from a group consisting of organic liquid, inorganic liquid, or a combination of inorganic liquid and organic liquid.

24. The system of claim 23 wherein the organic liquid is selected from a group consisting of acetonitrile, methanol, ethanol, tetrahydrofuran, isopropanol, and toluene.

25. The system of claim 1 wherein the electrolysis pump further comprising a plurality of chambers configured in series and containing same or different fluid inside each chamber.

26. The system of claim 1 further comprising a mixer on the same substrate coupled between the electrochemical pump system and the separation column, the mixer is configured such that different components of the elution provided by the electrochemical pump system are mixed with each other before entering the separation column.

27. The system of claim 1 wherein the electrochemical pump system and the separation column are disposed on the separated substrate with a fluidic connection between the electrochemical pump system and the separation column and are configured such that the electrochemical pump system provides the elution for the separation process inside the separation column.

28. The system of claim 1 further comprising a nozzle coupled to the separation column through the outlet of the separation column, the nozzle being adapted to output one or more separated components in a sequential order.

29. The system of claim 28 wherein the nozzle being coupled to transfer the one or more separated components to a mass spectrometry process using an electrospray ionization process.

30. The system of claim 1 further comprising a detection device coupled to separation column through the outlet of the separation column.

31. The system of claim 30 wherein the detection device being disposed on the same substrate with the separation column.

32. The system of claim 30 wherein the detection device is selected from a group consisting of a UV analyzer, a conductivity analyzer, a refractive index analyzer, a fluorescence analyzer, an electrochemical analyzer, a light scattering analyzer, and a mass spectrometer.

33. The system of claim 1 wherein the electrochemical pump system and the separation column are constructed from at least one selected from a group consisting of multi-chip packaging, injection molding, photolithography, dry etching, wet etching, evaporation, sputtering, and chemical vapor deposition.

34. A microfluidic system for electrospray ionization (ESI) and mass spectrometry (MS), the system comprising:
a substrate;
an electrochemical pump system disposed on the substrate, the electrochemical pump system comprising a plurality of electrolysis pumps and having at least one outlet; each of the electrolysis pumps comprising:
a chamber;
a plurality of electrodes, the electrodes being coupled to an electrical source;
a fluid inside the chamber, and the fluid being contacted with the electrodes; and
an inlet and an outlet;
an electrospray ionization (ESI) nozzle disposed on the substrate, the ESI nozzle having an inlet, an outlet, a micro channel coupled between the inlet and the outlet, and an ESI electrode within the micro channel; the inlet of the ESI nozzle being coupled to the outlet of the electrochemical pump system;
a mass spectrometer, the mass spectrometer including an inlet, the inlet being coupled to the outlet of the ESI nozzle;
wherein the electrochemical pump system and the ESI nozzle are configured such that the electrochemical pump system provides a driving force to cause the fluid to flow through the micro channel of the ESI nozzle and flow out through the outlet of the ESI nozzle; and the fluid emitted from the outlet of the ESI nozzle is transferred to the mass spectrometer as a voltage source is applied between the ESI electrode and the mass spectrometer.

35. The system of claim 34 wherein the plurality of electrolysis pumps are configured in parallel.

36. The system of claim 34 wherein the plurality of electrolysis pumps are configured in serial.

37. The system of claim 34 wherein the plurality of electrolysis pumps are configured in parallel and serial.

38. The system of claim 34 wherein the electrical source is selected from a group consisting of a voltage source, a current source, and a voltage/current source.

39. The system of claim 34 wherein the electrolysis pump is adapted to maintain a pressure on the fluid in the chamber while the electrodes are biased using the electrical source.

40. The system of claim 39 wherein the pressure is less than 1000 psia.

41. The system of claim 39 wherein the pressure is less than 100 psia.

42. The system of claim 34 wherein the chamber comprises about 1 micro liter of fluid.

43. The system of claim 34 wherein the chamber comprises greater than about 1 micrometer of fluid.

44. The system of claim 34 wherein the chamber comprises less than about 1 micrometer of fluid.

45. The system of claim 34 wherein the electrochemical pump system is characterized to provide a flow rate of about 1 nanoliter per minute to about 1 micro liter per minute through the separation column.

46. The system of claim 34 wherein the electrochemical pump system is characterized to provide a flow rate of less than about 1 nanoliter per minute through the separation column.

47. The system of claim 34 wherein the electrochemical pump system is characterized to provide a flow rate of greater than about 1 micro liter per minute through the separation column.

48. The system of claim 34 wherein the chamber and the ESI nozzle are made of materials including Parylene.

49. The system of claim 34 wherein the chamber and the ESI nozzle are made of materials selected from a group consisting of SU-8, silicone, silicon, silicon oxide, glass, Teflon, PEEK, and other polymer materials.

50. The system of claim 34 wherein the electrodes of the electrolysis pumps and the ESI electrode are made of at least a material selected from a group consisting of carbon, platinum, gold, aluminum, titanium, chromium, and other noble metals.

51. The system of claim 34 wherein the fluid being an electrolyte that is selected from a group consisting of organic liquid, inorganic liquid, or a combination of inorganic liquid and organic liquid.

52. The system of claim 51 wherein the organic liquid is selected from a group consisting of acetonitrile, methanol, ethanol, tetrahyrdrofuran, isopropanol, and toluene.

53. The system of claim 34 wherein the electrolysis pump further comprising a plurality of chambers configured in series and containing same or different fluid inside each chamber.

54. The system of claim 34 further comprising a mixer on the same substrate coupled between the electrochemical pump system and the ESI nozzle, the mixer is configured such that different fluids injected from the electrochemical pump system are mixed with each other before entering the ESI nozzle.

55. The system of claim 34 wherein the electrochemical pump system and the ESI nozzle are disposed on the separated substrate with a fluidic connection between the electrochemical pump system and the ESI nozzle and are configured such that the electrochemical pump system provides the driving force to push the fluid through the ESI nozzle, and the fluid emitted from the outlet of the ESI nozzle is transferred to the mass spectrometer as a voltage source is applied between the ESI electrode and the mass spectrometer.

56. The system of claim 34 wherein the electrochemical pump system and the ESI nozzle are constructed from at least one selected from a group consisting of multi-chip packaging, injection molding, photolithography, dry etching, wet etching, evaporation, sputtering, and chemical vapor deposition.

57. A method for transferring fluid on a microfluidic chip based on an electrochemical actuation, the method comprising:
transferring a fluid into a chamber through an inlet within a substrate;
providing an electrical connection using a plurality of electrodes coupled to the chamber;
transferring a portion of the fluid from the chamber through an outlet while applying an electrical energy to the plurality of electrodes using the electrical connection, whereupon the portion of the fluid is transferred free from any coupling to an external fluidic source;
wherein the transferring a portion of the fluid is performed in response to the electrical energy applied to the plurality of electrodes.

58. The method of claim 57 further comprising using the portion of the fluid for a separation process.

59. The method of claim 57 further comprising transferring the portion of the fluid through a nozzle.

60. The method of claim 57 further comprising sealing the fluid in the chamber.

61. The method of claim 57 further comprising isolating the fluid in the chamber.

62. The method of claim 57 wherein the transferring of the portion of the fluid is provided only by applying the electrical energy to the microfluidic chip.

63. A method for controlling fluid through a microfluidic system in a liquid chromatography application, the method comprising:
transferring fluid from an inlet into a chamber, the chamber being formed on a first portion of a substrate, the chamber comprising a plurality of electrodes, the plurality of electrodes being configured to apply electrical forces to the fluid;
applying an electrical source between the plurality of electrodes;
causing an electrochemical reaction within the chamber based upon the application of the electrical source onto the electrodes, the electrodes being coupled to the fluid; and
generating a gaseous species from the electrochemical reaction to increase a pressure within the chamber;
coupling a separation column to the chamber;
using the pressure in the chamber to provide driving force for the elution in the separation column for liquid chromatography; and
controlling the elution by adjusting the electrical source that applied the plurality of electrodes.

64. The method of claim 63 wherein the electrical forces comprise an electrical current.

65. The method of claim 63 wherein the electrical forces comprise a voltage.

66. The method of claim 63 wherein the elution being isocratic.

67. The method of claim 63 wherein the elution being gradient.

68. The method of claim 63 wherein the pressure in the chamber also provide driving force for a sample injection in the separation process.

69. The method of claim 63 further comprising capturing a signal associated with a parameter of the fluid in the chamber; and using the captured signal to adjust a level of the electrical source between the plurality of electrodes.

70. The method of claim 63 wherein the fluid in the chamber is a first fluid and the separation column comprises a second fluid, the first fluid being different from the second fluid, whereupon the second fluid being separated into one or more components as the second fluid passes through the separation column.

71. The method of claim 63 further comprising transferring the one or more components in a sequential manner from the separation column through a nozzle, the nozzle being coupled to the separation column.

72. A method for controlling fluid through a microfluidic system in a liquid chromatography application, the method comprising:
applying an electrical source between a plurality of electrodes to cause an electrochemical reaction within a first fluid in a chamber coupled to the plurality of electrodes;
generating a gaseous species from the electrochemical reaction in the first fluid to increase a pressure within the chamber; and
transferring a second fluid through a separation column using the pressure associated with the chamber for liquid chromatography.

73. The method of claim 72 wherein the first fluid is a working media for the electrochemical reaction and the second fluid is a solvent for liquid chromatography.

74. The method of claim 72 further comprising transferring the one or more components in a sequential manner from the separation column through a nozzle, the nozzle being coupled to the separation column.

75. A method for performing liquid chromatography using a multichamber arrangement, the method comprising:
applying an electrical source between a plurality of electrodes to cause an electrochemical reaction within a first fluid in a first chamber, the first chamber being among a plurality of chambers, each of the chambers being numbered from 1 through N, where N is an integer greater than 1, the first fluid being from a plurality of fluids numbered from 1 through N, each of the fluids being respectively associated with each of the chambers;
generating a gaseous species from the electrochemical reaction in the first fluid to increase a first pressure within the first chamber;
transferring a first liquid chromatography fluid from a first reservoir to a separation column for liquid chromatography using the first pressure associated with the first chamber, the first liquid chromatography fluid being from a plurality of liquid chromatography fluids numbered from 1 through N, each of the liquid chromatography fluids being associated with a respective reservoir also numbered from 1 through N; and
applying, generating, and transferring for any of the other chambers including any of the other respective fluids and reservoirs.

76. The method of claim 75 wherein the first fluid is a working media for the electrochemical reaction and the first liquid chromatography fluid is for liquid chromatography.

77. The method of claim 75 wherein the applying, generating, and transferring for the first chamber is performed simultaneously with steps of applying, generating, and transferring for any of the other chambers.

78. The method of claim 75 wherein the applying, generating, and transferring for the first chamber is performed sequentially with steps of applying, generating, and transferring for any of the other chambers.

79. The method of claim 75 wherein each of the fluids numbered from 1 through N is a similar substance.

80. The method of claim 75 wherein each of the liquid chromatography fluids numbered from 1 through N is a similar substance.

81. A method for controlling fluid through a microfluidic system for ESIMS, the method comprising:
transferring a first fluid from an inlet into a chamber, the chamber being formed on a first portion of a substrate, the chamber comprising a plurality of electrodes, the plurality of electrodes being configured to apply electrical forces to the first fluid;
applying an electrical source between the plurality of electrodes;
causing an electrochemical reaction within the chamber based upon the application of the electrical source onto the electrodes, the electrodes being coupled to the first fluid; and
generating a gaseous species from the electrochemical reaction to increase a pressure within the chamber, the chamber being coupled to an ESI nozzle;
using the pressure in the chamber to provide a driving force to cause an injection at a certain rate of a second fluid through the ESI nozzle for use in a mass spectrometer;
controlling the rate of the injection by adjusting an electrical source coupled to the plurality of electrodes.

82. The method of claim 81 wherein the electrical forces comprise an electrical current.

83. The method of claim 81 wherein the electrical forces comprise a voltage.

84. The method of claim 81 further comprising capturing a signal associated with a parameter of the first fluid in the chamber; and using the captured signal to adjust a level of the electrical source between the plurality of electrodes.

85. The method of claim 81 wherein the first fluid from the inlet into the chamber is different from the second fluid through the ESI nozzle, whereupon the second fluid being coupled to a MS through ESI process as the second fluid being injected from the ESI nozzle and a voltage source being applied between the ESI nozzle and the MS.

86. The method of claim 81 wherein the first fluid from the inlet into the chamber is the same as the second fluid through the ESI nozzle, whereupon the second fluid being coupled to a MS through ESI process as the second fluid being injected from the ESI nozzle and a voltage source being applied between the ESI nozzle and the MS.
